(19) United States
(12) Patent Application Publication
(10) Pub. No.: US 2020/0349654 A1
(43) Pub. Date: Nov. 5, 2020

(54) Transaction Lifecycle Monitoring

(71) Applicant: Goldman Sachs & Co. LLC, New York, NY (US)

(72) Inventors: Shahin Mahmoud Shahin, Clifton, NJ (US); Jonathan David Lavi, New York, NY (US); Thomas Josef Kobrick, New York, NY (US); Amul Sunilbhai Mehta, Jersey City, NJ (US); Stanislav Perevozchikov, Long Island City, NY (US); Rajesh Kapoor, Bengaluru (IN)

(21) Appl. No.: 16/920,280

(22) Filed: Jul. 2, 2020

Related U.S. Application Data
(63) Continuation-in-part of application No. 16/400,710, filed on May 1, 2019.

(30) Foreign Application Priority Data
Apr. 4, 2020 (IN) 202041014972

(51) Int. Cl. G06Q 40/00; G06F 3/0482

(52) U.S. Cl. CPC G06Q 40/12; G06F 3/0482

(57) ABSTRACT

A transaction lifecycle monitoring system generates reports indicating the current status of transactions at multiple transaction processing steps. The report is generated from data generated by multiple transaction processing systems. Each transaction processing system may use a different identifier to identify the transaction. The transaction lifecycle monitoring system maintains mappings between different identifiers used by the various processing systems to identify the same transaction. The report may include a timeline with geometric shapes corresponding to processing steps in the transaction's lifecycle. The status of the transaction at each processing step may be indicated by a visual property (e.g., color) of the corresponding geometric shape.

### CROSS-REFERENCE TO RELATED APPLICATIONS

This application is a continuation-in-part of U.S. application Ser. No. 16/400,710, filed on May 1, 2019, and claims priority to Indian Patent Application No. 202041014972, filed Apr. 4, 2020, both of which are incorporated by reference.

### BACKGROUND

### 1. Technical Field

The subject matter described generally relates to transaction monitoring, and in particular to a user interface for tracking the lifecycles of payment transactions across multiple transaction processing systems.

### 2. Background Information

Processing and executing corporate, institutional, governmental, and consumer payments is a highly complex process involving numerous processes, components, and systems. In simple terms, a payment transaction is the transfer of money (cash) from one party to another party (known as payor and payee or debtor and creditor). Today, electronic payment systems process large volumes of payment transactions daily. In such an electronic payment transaction, a payor instructs a financial institution to transfer money electronically from an account the payor has with the financial institution to an account of the payee. The payee's account may be with the same financial institution as the payor's account or a different financial institution.

Existing electronic payment systems receive a payment request and determine whether the payment should be approved or denied. If a payment is denied, it may be several hours before the payor is notified and the reason for denial may not be immediately apparent, requiring further analysis to determine the root cause or causes. Furthermore, the payor and payee have little information about the status of the payment until it is either approved or denied.

### SUMMARY

Additional insight into transaction processing can be provided using aspect-oriented programming techniques to extract more granular status information regarding transaction status that is available using conventional approaches. Generally, an orchestration platform processes transactions through a series of transaction processing steps. Advices may be applied to the transaction processing code at pointcuts before or after processing steps. The advices extract transaction status information that is provided to a transaction monitoring system. The transaction monitoring system provides a user interface that enables users to monitor the status of transactions as they proceed through the various processing steps.

Any given transaction may have multiple identifiers throughout its lifecycle. For example, the systems of a transaction generator may assign a first identifier, the payment orchestration platform may assign a second identifier, and the clearing network may assign a third identifier. In one embodiment, the transaction orchestration platform maintains mappings between different identifiers that correspond to a transaction. The transaction orchestration platform may stitch together status information from each system involved in processing the transaction using the mappings. Thus, a user interface may be generated that includes information regarding the transaction's entire lifecycle.

In various embodiments, if exceptions or other potential issues arise during the processing of a transaction, a relevant user (e.g., the payor, payee, or an agent of the entity that provides the orchestration platform) may see the issue in the user interface. If the exception can be addressed before the transaction fails completely, the user may take corrective action, such as providing additional information, and transaction processing may resume. For example, if an exception occurs because a transaction request is incorrectly formatted, the payor may correct the formatting and have transaction processing resume, rather than the whole transaction fail, requiring the payor to submit a new transaction request. In some embodiments, the transaction monitoring system may aggregate extracted status information and provide reports or other summaries indicating trends or providing other historical analysis.

### BRIEF DESCRIPTION OF THE DRAWINGS

FIG. 1 is a block diagram of a networked computing environment suitable for providing transaction lifecycle monitoring, according to one embodiment.

FIG. 2 is a block diagram of the transaction orchestration platform of FIG. 1, according to one embodiment.

FIG. 3 is a block diagram of the data store of FIG. 2, according to one embodiment.

FIGS. 4A and 4B are flowcharts illustrating a method for extracting information from an existing transaction process, according to one embodiment.

FIG. 5 is a block diagram illustrating the transaction monitoring system of FIG. 1, according to one embodiment.

FIG. 6 is a flowchart illustrating a method for transaction lifecycle monitoring, according to one embodiment.

FIG. 7 is a flowchart illustrating a method for providing a report on the current status of a transaction, according to one embodiment.

FIGS. 8A-H illustrate components of an example user interface for viewing the status of a transaction, according to one embodiment.

FIG. 9 is a block diagram illustrating an example of a computer suitable for use in the networked computing environment of FIG. 1, according to one embodiment.

### DETAILED DESCRIPTION

The figures and the following description describe certain embodiments by way of illustration only. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described for monitoring the lifecycles of financial transactions. However, one of skill in the art will recognize that similar approaches may be used to process other types of transaction. One skilled in the art will also recognize that alternative embodiments of the structures and methods may be employed without departing from the principles described. Reference will now be made to several embodiments, examples of which are illustrated in the accompanying figures.

Example Computing Environment

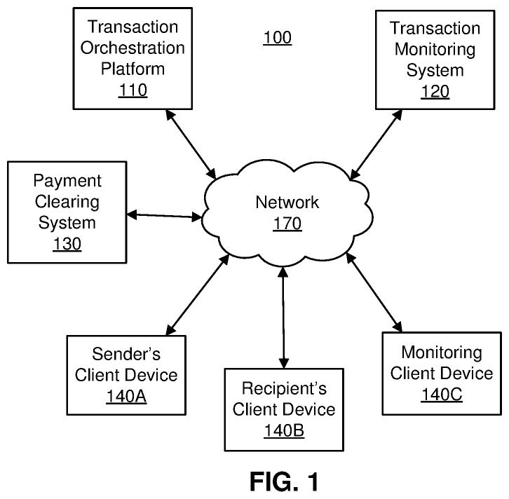

FIG. 1 illustrates one embodiment of a networked computing environment 100 suitable for providing transaction lifecycle monitoring. In the embodiment shown in FIG. 1, the networked computing environment 100 includes a transaction orchestration platform 110, a transaction monitoring system 120, a payment clearing system 130, a sender's client device 140A, a recipient's client device 140B, and a monitoring client device 140C, all connected via a network 170. In other embodiments, the networked computing environment 100 contains different or additional elements. In addition, the functions may be distributed among the elements in a different manner than described. For example, although the transaction orchestration platform 110 and the transaction monitoring system 120 are shown as separate entities, in some embodiments, the corresponding functionality may be provided by a single server or group of servers.

The transaction orchestration platform 110 facilitates transactions between entities. The transaction orchestration platform 110 receives transaction requests (e.g., from senders' client devices 140A) through one or more channels. The transaction orchestration platform 110 performs a set of processing steps to approve or reject transactions. If exceptions are identified during processing of a transaction, the transaction orchestration platform 110 may route the transaction to an exception queue for further processing. Assuming the transaction is ultimately approved, the transaction orchestration platform 110 may provide details of the transaction to a payment facilitator to execute the transaction.

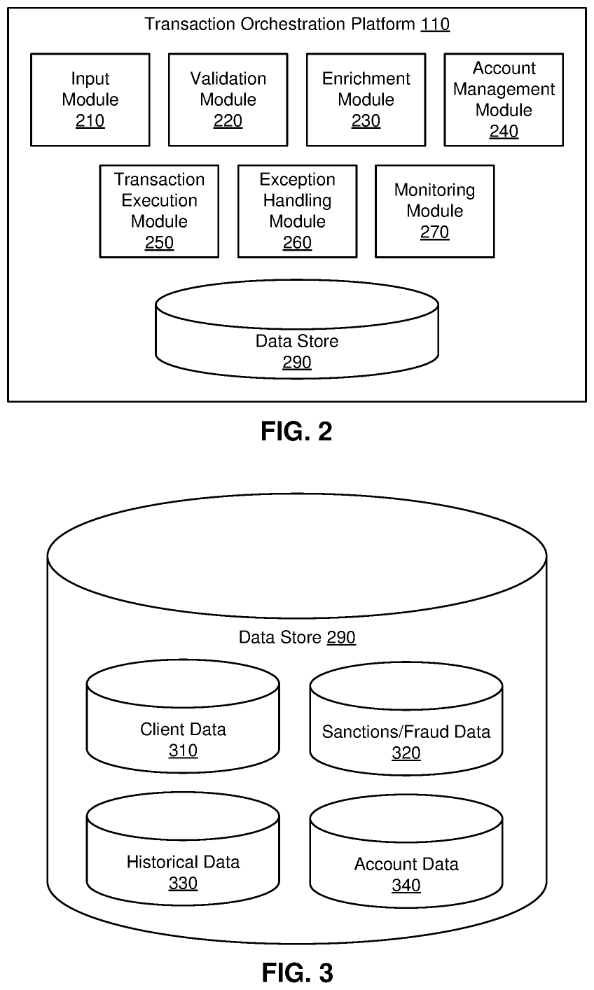

In various embodiments, pointcuts are used to apply advices before or after some or all of the processing steps. The advices extract transaction status information and provide it to the transaction monitoring system 120. The advices may be applied without altering the code that implements the set of transaction processing steps. Thus, the advices may be added to existing transaction processing systems, even where the operator cannot alter the transaction processing code (e.g., due to regulatory or contractual requirements). Embodiments of the transaction orchestration platform 110 are described in greater detail below, with reference to FIGS. 2-4.

The transaction monitoring system 120 receives transaction status information from the transaction orchestration platform 110 (e.g., the status information extracted by the advices). In various embodiments, the transaction monitoring system 120 includes one or more interfaces to provide users with insights into transaction processing. For example, the interfaces may include a graphical user interface (GUI) and an application programming interface (API) that enable users to monitor transaction progress, generate alerts, and take corrective action. The interface may also include one or more reporting tools for identifying trends and performing other historical analysis. Various embodiments of the transaction monitoring system 120 are described in greater detail below, with reference with FIG. 5.

The payment clearing system 130 receives information regarding transactions from the transaction orchestration platform 110 and settles those transactions on behalf of a clearing service. Examples of payment clearing services include the Faster Payments Service and SWIFT networks. Although only one payment clearing system 130 is shown, the networked computing environment 100 may include many such systems. For example, the transaction orchestration platform 110 may be configured to enable transactions to be settled through multiple different clearing networks.

The client devices 140 are computing devices capable of communicating with the transaction orchestration platform 110 or transaction monitoring system 120 via the network 170. For example, a client device 140 may be a desktop computer, a laptop computer, a smartphone, a tablet, a set top box, personal digital assistant, or the like. A sender's client device 140A is configured to submit a transaction request to the transaction orchestration platform 110, a recipient's client device 140B is configured to receive notification of incoming transactions, and a monitoring client device 140C is configured to interface with the transaction monitoring system 120 to present transaction status information to a user. Although FIG. 1 only shows one of each type of client device 140, in practice, the networked computing environment 100 may include many (e.g., thousands or millions of) such devices. Furthermore, a given client device 140 may provide the functionality of two or more types. For example, a user may use a single client device 140 to submit a transaction to the transaction orchestration platform 110 and then interface with the transaction monitoring system 120 to monitor the progress of the transaction (and take further action as appropriate).

The network 170 provides the communication channels via which the other elements of the networked computing environment 100 communicate. The network 170 can include any combination of local area and/or wide area networks, using both wired and/or wireless communication systems. In one embodiment, the network 170 uses standard communications technologies and/or protocols. For example, the network 170 can include communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). All or some of the communication links of the network 170 may be encrypted using any suitable technique or techniques.

Example Transaction Orchestration Platform

FIG. 2 illustrates one embodiment of the transaction orchestration platform 110. In the embodiment shown in FIG. 2, the transaction orchestration platform 110 includes an input module 210, a validation module 220, an enrichment module 230, an account management module 240, a transaction execution module 250, an exception handling module 260, a monitoring module 270, and a data store 290. In other embodiments, the transaction orchestration platform 110 contains different or additional elements. In addition, the functions may be distributed among the elements in a different manner than described.

The input module 210 receives transaction requests from one or more sources. A transaction request includes information regarding a desired transaction, such as a payee identifier (e.g., a payee ID number), a payor ID (e.g., a payor ID number), a value to transfer, a currency (or other form) in which the value should be transferred, etc. On receiving a new transaction request, the input module 210 assigns the transaction a transaction ID. In one embodiment, transaction requests may be generated by a payment GUI (e.g., a form on a website), a mobile interface (e.g., an app executing on a smartphone), or an API (e.g., used by a third-party application). In other embodiments, different or additional mechanisms may be used to generate transaction requests.

The validation module 220 performs validation checks on transaction requests. In one embodiment, on receiving a transaction request (e.g., from the input module 210), the validation module 220 retrieves relevant information from one or more datastores (e.g., datastore 290). The relevant information for a given transaction request may include: payor and payee names, payor and payee addresses, default financial accounts for the payor and payee, preferred currency for the payor and payee, specific validation checks required by the payor and payee (if any), or any other information about the transaction.

The validation module 220 performs specific validation checks required by the payor, payee, the financial institution of the payor, the financial institution of the payee, governmental and regulatory bodies, and any other pertinent entities. The validation module 220 may also validate the format of the transaction request. For example, by confirming that all required fields are completed and include appropriate values (e.g., payments in a given currency may be limited to a specified range of values). If the validation module 220 detects an exception (e.g., if a validation check fails), the transaction request is added to an exception queue for further processing (e.g., as described below with reference to the exception handling module 260). In one embodiment, possible exceptions include: the payor is an invalid party, the payee is an invalid party; the currency used in the request is not acceptable, and the transaction is not correctly formatted. Other embodiments may include different or additional validation exception types.

Transaction requests that are successfully validated are passed to the enrichment module 230. The enrichment module 230 may add additional details to a transaction request such as credit-related information (e.g., a credit limit for the payor). The enrichment module 230 may also perform checks for exceptions based on sanctions or fraud. In one embodiment, the enrichment module 230 retrieves information on sanctioned individuals, corporations, governmental agencies or other entities from a database (e.g., datastore 290). The transaction request is compared with the retrieved information to determine if any sanctions/fraud rules or regulations are violated. If a violation is detected, the enrichment module 230 routes the transaction to the exception queue for further processing.

Transactions that pass the sanctions/fraud checks are passed to the account management module 240. In one embodiment, the account management module 240 accesses account data for the payor and payee (e.g., from datastore 290). The account data may include available cash balances in one or more currencies. The account management module 240 may also perform debits and deposits for each affected account. For example, when a payor requests a payment to a payee, the payor's account may be debited the intended amount and the payee's account may be credited with the intended amount. Note that these debits and credits may be to the payor's and payee's balances within the transaction orchestration platform 110 (e.g., in a ledger) not an implementation of the transaction itself (e.g., by transferring cash from the payor's bank account to the payee's bank account).

Rather, the transaction execution module 250 executes transactions. In one embodiment, the transaction execution module 250 executes a transaction by sending it to a payment facilitator or executor (e.g., payment clearing system 130) via a gateway. There may be numerous payment facilitators or payment executors. Some networks (e.g., SWIFT) provide instructions only on how a payment should be executed leaving the details of the settlement of the actual payment to the payor's and payee's financial institutions. Other networks (e.g., Fedwire) not only allow institutions to provide instructions on how to execute a payment, but will also settle the payment transaction by performing cash movements between the accounts of the payor and payee. Which payment facilitator or executor is used may be determined based on one or more of: a preference included in the transaction request, preferences in the payor's profile, preferences in the payee's profile, parameters of the transaction (e.g., amount, currency, jurisdiction, etc.), etc. The transaction execution module 250 may also add details of the transaction to a database (e.g., datastore 290) for historical tracking. These details may include the payor's and payee's information (e.g., name, account number, etc.), the amount of cash and the associated currency the payment was transacted with, the date and time the payment took place, etc.

The exception handling module 260 processes transactions that are added to the exception queue by other modules (e.g., the validation module 220 or enrichment module 230). The manner in which an exception is processed may depend on the type of exception. For example, if a transaction that triggers an exception based on sanctions or fraud, the exception handling module 260 might generate a report to appropriate parties, such as a compliance officer, a regulatory body, or the like. In contrast, an exception generated due to a transaction being incorrectly formatted may be processed to determine if the formatting can be automatically or semi-automatically corrected. As another example, an exception may be automatically generated if the amount of a transaction exceeds a pre-defined threshold (e.g., $1 billion). The exception handling module 260 may send a notification to a designated person with authority to approve large transactions and not allow processing of the transaction to proceed until that person provide explicit authorization for the transaction.

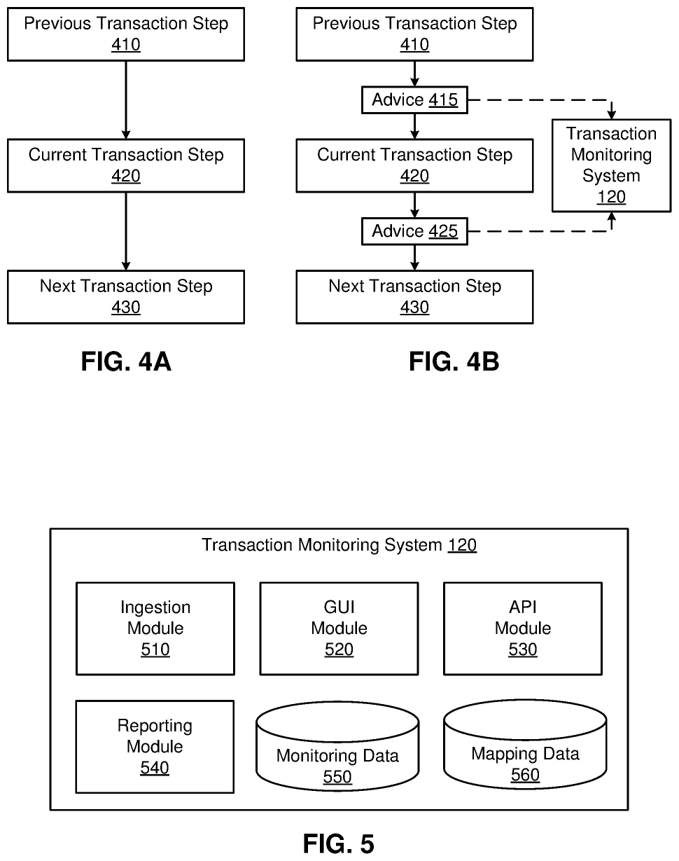

The monitoring module 270 aggregates information regarding transaction requests at various stages during processing and provides it to the transaction monitoring system 120. The information may represent the status of a transaction request before and after various processing steps. For example, in one embodiment, the monitoring module 270 aggregates information regarding a transaction request from before and after processing by each of the validation module 220, the enrichment module 230, the account management module 240, and the transaction execution module 250. In other embodiments, the monitoring module 270 may obtain information at different or additional stages of the processing of transaction requests. Various embodiments for extraction and aggregation of information regarding a transaction request are described in greater detail below, with reference to FIGS. 4A and 4B.

The data store 290 includes one or more computer-readable media that store data used by the transaction orchestration platform 110. FIG. 3 illustrates one embodiment of the data store 290. In the embodiment shown, the data store 290 stores client data 310, sanctions/fraud data 320, historical data 330, and account data 340. In other embodiments, the data store 290 may store different or additional data. Furthermore, although the data store 290 is shown as a single entity, the stored data may be distributed across multiple devices or storage media. For example, in one embodiment, the data store 290 is a database distributed across multiple servers.

The client data 310 includes information about clients of the transaction orchestration platform 110. In one embodiment, each client has a profile with the transaction orchestration platform 110 that is assigned a unique client ID. The client data 310 includes information about the corresponding client stored in conjunction with each unique client ID. For example, for a given client, the client data 310 may include a name, contact address, other identifying information (e.g., a complete or partial social security number or tax identification number), whether the client is an individual or an entity, currency preferences, etc. The profile may be created by the entity managing the transaction orchestration platform 110. Additionally or alternatively, in some embodiments, clients may be able to create their own profiles (e.g., as part of a registration process).

The sanctions/fraud data 320 includes information on sanctioned individuals, corporations, governmental agencies, or other entities. In one embodiment, the sanctions/fraud data 320 includes identifying information associated with sanctioned entities stored in conjunction with indicators of what sanctions currently apply. For example, an entry might include a name, whether the entity is an individual or other legal entity, an address, and other identifying information (e.g., a complete or partial social security number or tax identification number) along with an indication of the source and type of sanctions applied to that entity. In other embodiments, the sanctions/fraud 320 data may include different or additional information regarding sanctioned entities.

The historical data 330 includes a history of previous transactions. In one embodiment, the historical data 330 includes an identifier of the payor and payee (e.g., unique client IDs); the value transferred and currency used; and the date and time the transaction was received or executed. The historical data 330 may be used to identify trends in use of the transaction orchestration platform 110. In other embodiments, the historical data 330 may include different or additional information about processed transactions.

The account data 340 includes information about clients' accounts. As used herein, “account” refers to an account for storing value (e.g., a bank account) that is controlled or otherwise accessible for a client in contrast to “profile” which is used to refer to a collection of information about a client. In one embodiment, for each client, the account data 340 includes identifiers of one or more accounts in conjunction with information about those accounts (e.g., currency, balance, etc.). The account data 340 may include a ledger that is updated substantially in real time (e.g., within a few seconds) of transactions requests being received to provide a more accurate indication of the amount of cash available than may be provided by the financial institution that provides the account. For example, the financial institution may only report the previous end-of-day balance of the account, whereas the ledger can provide a substantially real-time measure of cash availability in view of other transaction requests involving the same account. In other embodiments, the account data 340 may include different or additional information regarding clients' accounts.

Example Approach for Extracting Transaction Information

FIG. 4A illustrates a portion of existing code for processing a transaction request. In particular, the transaction request is passed from a previous transaction step 410 to a current transaction step 420 and on to a next transaction step 430. For example, the previous transaction step 410 might be the validation tests performed by the validation module 220, the current transaction step 420 might be the sanctions/fraud checks performed by the enrichment module 230, and the next transaction step might be the account credit/debit operations performed by the account management module 240. However, the three transaction steps may be any set of consecutive processes performed in orchestrating a transaction.

FIG. 4B illustrates the same portion of existing code as FIG. 4A with the addition of a pre-execution advice 415 and a post-execution advice 425. The advices 415, 425 extract information regarding the transaction request being processed and send it to the transaction monitoring system 120. The pre-execution advice 415 is applied at a first pointcut located before the code that implements the substantive elements of the current transaction step 420 and the post-execution advice 425 is applied at a second pointcut located after the code that implements the substantive elements of the current transaction step 420. Thus, the transaction monitoring system 120 may use the extracted information to analyze the impact of the current transaction step 420. Note that either the previous transaction step 410, the next transaction step 430, or both may have corresponding pre- and post-advices as well.

In one embodiment, the pre-execution advice 415 captures the current date and time (before the current transaction step 420 begins), the identity of the payor and payee, and any input variables provided to the current transaction step 420. Similarly, the post-execution advice 425 captures the date and time (after completion of the current transaction step 420), the amount of time taken to execute the current transaction step 420, the outputs from the current transaction step 420, and any exceptions or errors that occurred during processing of the current transaction step 420. In other embodiments, the advices may capture different or additional information regarding the transaction request.

Although FIG. 4B only shows advices on either side of one transaction step, in practice, pairs of advices sandwich more (e.g., all of the) transaction request processing steps. Thus, as a transaction request proceeds through the various processing requests, the advices extract information and provide it to the transaction monitoring system 120. The transaction monitoring system 120 uses the extracted information to generate UIs for providing status updates regarding the transaction request and, in some embodiments, enable users to take corrective action to address errors and exceptions. The transaction processing system 120 may also use the extracted information to generate reports to identify trends and perform other forensic analysis.

Example Transaction Monitoring System

FIG. 5 illustrates an embodiment of the transaction monitoring system 120. In the embodiment shown, the transaction monitoring system 120 includes an ingestion module 510, a GUI module 520, an API module 530, a reporting module 540, monitoring data 550, and mapping data 560. In other embodiments, the transaction monitoring system 120 contains different or additional elements. In addition, the functions may be distributed among the elements in a different manner than described. For example, some embodiments may not include an API module 530 or a reporting module 540.

The ingestion module 510 receives transaction request information extracted by advices of the transaction orchestration platform 110 (e.g., via the network 170). The ingestion module 510 also receives information about the extraction from some or all of the other entities that are involved in processing the transaction, such as the sender's client device 140A and the payment clearing system 130. In some embodiments, some or all of the entities involved in the transaction have their own identifiers for the transaction. For example, a single transaction may have three different identifiers: one assigned by the sender's systems (e.g., sender's client device 140A), one assigned by the transaction orchestration platform 110, and one assigned by the payment clearing system 130. The ingestion module 510 identifies transaction identifiers that correspond to the same transaction and stores mappings between them (e.g., in mapping data 560).

In one such embodiment, when the input module 210 of the transaction orchestration platform 110 receives a new transaction request, the request includes the identifier assigned to the transaction by the sender's systems. Thus, when the input module 210 assigns the request a transaction ID, it has access to both the ID assigned by the sender's systems and itself. Therefore, an advice may extract and provide both of these IDs to the transaction monitoring system 120, enabling the ingestion module 510 to store a mapping between the ID used by the sender's systems and the ID assigned by the transaction monitoring system (e.g., in the mapping data 560). Similarly, when the transaction request is sent to the payment clearing system 130 and assigned a clearing ID, the transaction ID used by the orchestration platform 110 and the clearing ID may be provided to the transaction monitoring system 120 to record a mapping between these two IDs.

In various embodiments, the ingestion module 510 maintains a data object (e.g., in the monitoring data 550) for each transaction request. When information regarding a transaction request is received from the first advice the ingestion module 510 instantiates a new data object for the transaction request. The fields of instantiated data object are initially empty, meaning they are either void or contain a default value. As additional information is received from each advice, the ingestion module 510 updates the data object. In one such embodiment, the data object for a transaction request includes the following fields:
Transaction ID: an identifier for the transaction, which is generally unique throughout time. Alternatively, identifiers may be recycled under certain conditions (e.g., after a specified amount of time has passed or after all valid identifiers have been used). The transaction ID may be an identifier used by one of the other systems in the network (e.g., the transaction orchestration platform 110) or may be assigned by the transaction monitoring system 120.
Payee: an identifier of the payee, such as the payee's name or a unique identifier (e.g., a client ID with the transaction orchestration platform 110).
Payee Account ID: an identifier of the payee's financial account identifier held at a bank. This account represents the running balance of cash available for the payee.
Payee Institution ID: an identifier of the payee's institution, which may be either a bank (or other financial institution) or a corporate entity. Generally, each financial institution and corporate entity is assigned a unique identifier.
Payor: an identifier of the payor, such as the payor's name or a unique identifier (e.g., a client ID with the transaction orchestration platform 110).
Payor Account ID: an identifier of the payor's financial account identifier held at a bank. This account represents the running balance of cash available for the payor.
Payor Institution ID: an identifier of the payor's institution, which may be either a bank (or other financial institution) or a corporate entity.
Transaction Method: an alphanumeric field representing the method of payment that the payor or the transaction orchestration platform 110 intends to use to execute the transaction. For example, the payor may instruct the transaction orchestration platform 110 to send a payment to a payee via the SWIFT network. Alternatively, the transaction orchestration platform 110 may choose a method of payment that will efficiently execute the transaction (e.g., by selecting the method that will: incur the least amount of fees and taxes or result in the fastest transfer of cash from the payor to the payee, etc.).
Transaction Amount: a decimal monetary amount representing the payment the payor wishes to send to the payee.
Origination Currency: an alphanumeric field representing the currency the payor will provide (e.g., U.S. Dollars, Euros, Japanese Yen, etc.).
Destination Currency: an alphanumeric field representing the currency the payee will receive (e.g., U.S. Dollars, Euros, Japanese Yen, etc.).
Transaction Date: a date (or alphanumeric) field representing the date on which the transaction request indicates the transfer of cash should occur.
Date Time Start: a timestamp (e.g., expressed as an alphanumeric field) indicating the date and time at which processing of the transaction request began. This may be generated when the transaction request is received by the transaction orchestration platform 110.
Date Time End: a timestamp (e.g., expressed as an alphanumeric field) indicating the date and time at which processing of the transaction request was completed. This may be generated when the transaction has been successfully executed or when the transaction orchestration platform 110 determined the transaction request cannot be executed.
Fee Amount: a monetary amount of the fee (or sum of fees) associated with executing the transaction.
Fee Currency: an alphanumeric field representing the currency of the fee
Fee Payor ID: an identifier of the entity paying the fee, which may either be the payor, the payee, the payor's or payee's institution, or some other entity responsible for the fee.
Tax Amount: a monetary amount representing the tax (or sum of taxes) associated with executing the transaction.
Tax Currency: an alphanumeric field representing the currency of the tax.
Tax Payor ID: an identifier of the entity paying the tax, which may be either the payor, the payee, the payor's or payee's institution, or some other entity responsible for the tax.
Exceptions: a list (or array) of zero or more exceptions or errors generated by the transaction orchestration platform 110 in processing the transaction request. Examples of exceptions or errors may include: technical errors associated with executing the transaction; an invalid payor or payee; the payor or payee participating in a fraudulent or sanctioned payment transaction; insufficient funds being available in the payor's account; etc.

In other embodiments, the data object may include different or additional fields and some of the fields may include different or additional information. Furthermore, some of the fields may be merged.

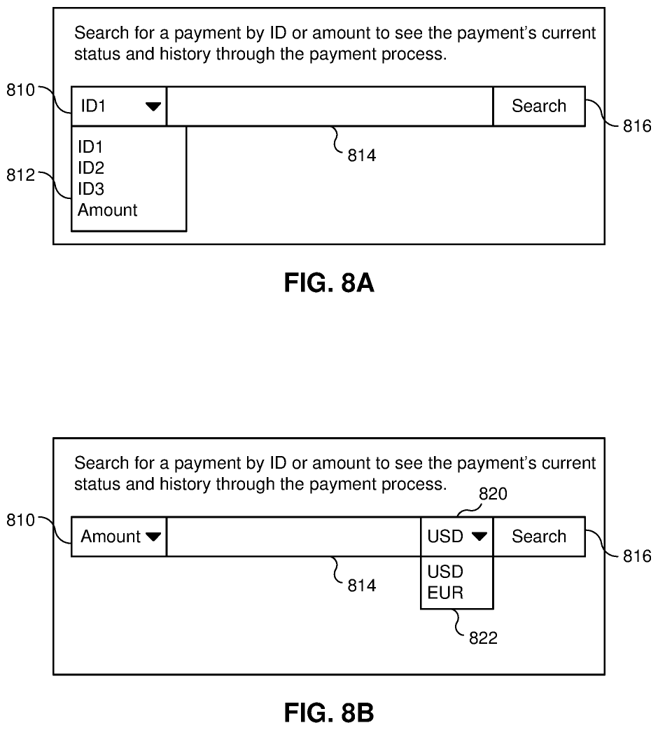

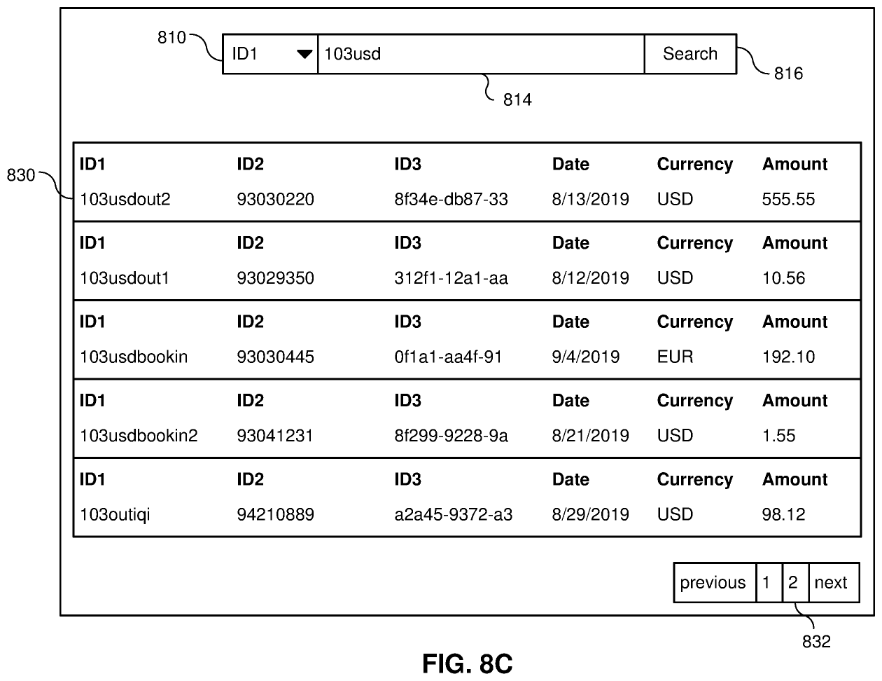

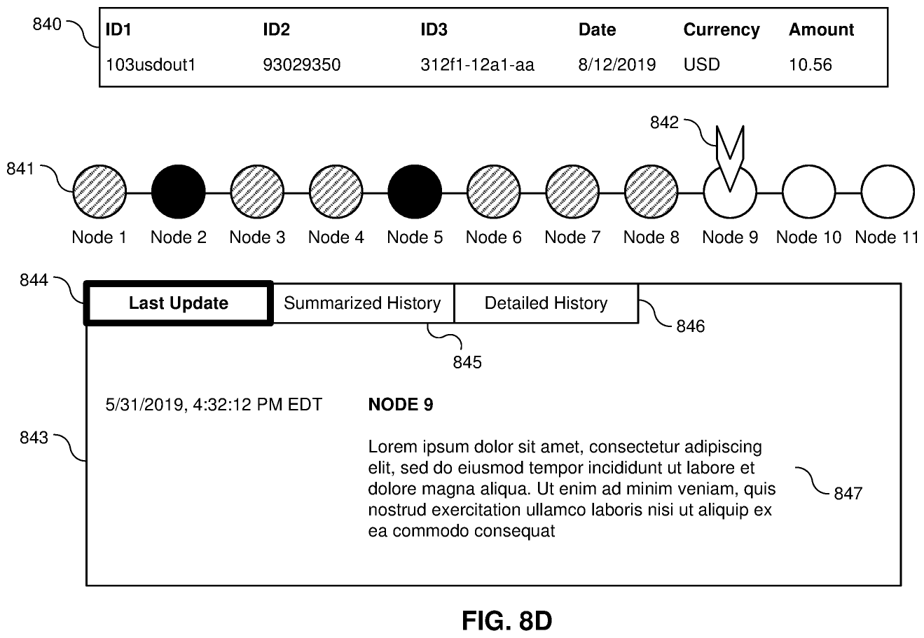

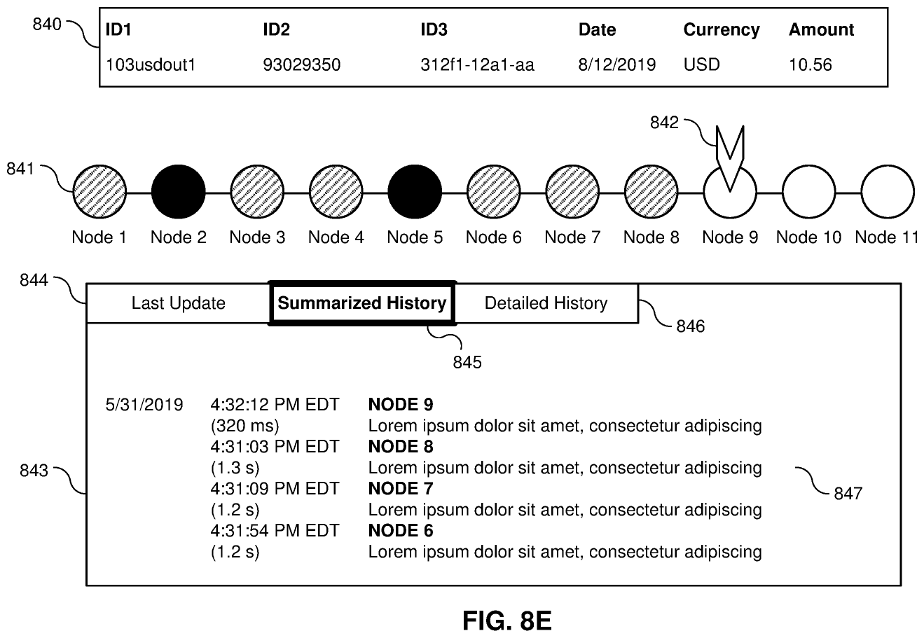

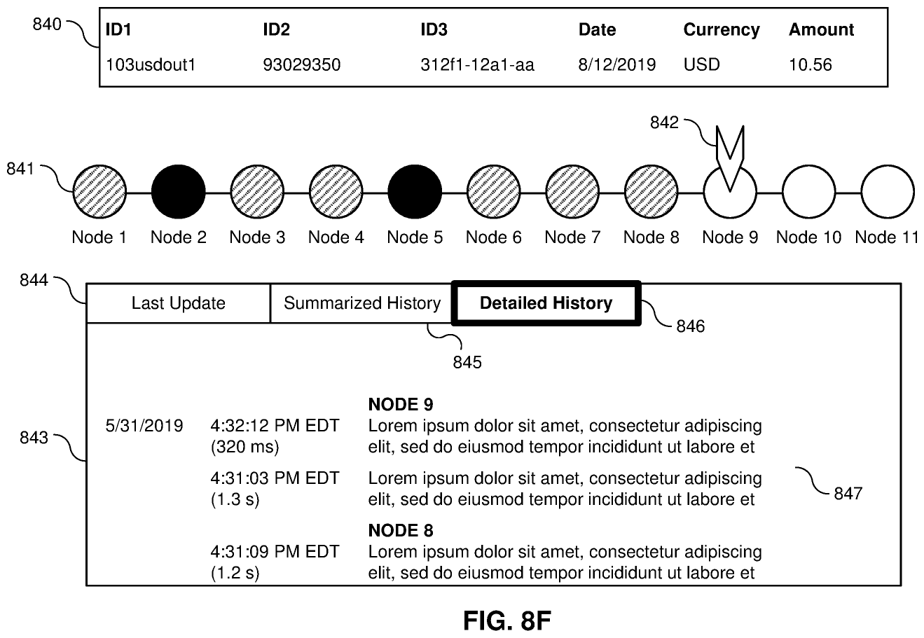

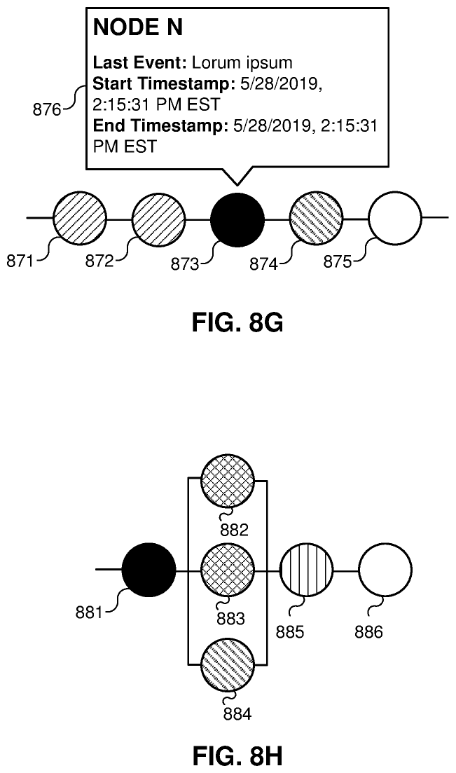

The GUI module 520 generates a GUI via which users may view the current status of pending transactions and information regarding the lifecycle of completed transactions. In one embodiment, the GUI is provided as part of a webpage that users access via the network 170 from a client device 140. A user provides identifying information for a transaction (e.g., a transaction ID, payor ID, payee ID, etc.) and the GUI presents status information for the transaction. If the identifying information does not uniquely identify a single transaction (e.g., if the user provides just a payor ID), the GUI may present a list of transactions and prompt the user to select the desired transaction. An embodiment of the GUI is described in greater detail below, with reference to FIGS. 8A-H.

The GUI may also provide tools with which the user can take corrective action if the current status of a transaction indicates a problem (e.g., the transaction orchestration platform 110 encountered an exception or error). For example, if a transaction triggers a sanctions-based exception, the user may provide evidence that the payor or payee is not the sanctioned entity, that the sanctions do not apply to the current transaction, or the like. As another example, if an exception is triggered because the payor has insufficient cash in their account, the user may identify a different account from which cash may be taken or add additional cash to the account and request that the transaction orchestration platform 110 attempts to process the transaction again.

The API module 530 provides an API with which other applications (e.g., third-party applications) may access the transaction request information. For example, a financial institution may develop its own GUI for employees to monitor transactions and take corrective action as appropriate. As another example, an entity may have an automated monitoring system that detects exceptions and triggers corrective action. The corrective action may be automated (e.g., adding additional cash to an account if needed to complete a transaction) or semi-automated (e.g., sending an email or other notification to an individual tasked with handling exceptions of the detected type).

The reporting module 540 generates reports based on the transaction information received from the transaction orchestration platform 110. The reports may be generated on a fixed schedule (e.g., daily, weekly, monthly, etc.), when certain triggering conditions are met (e.g., every ten thousand transactions), or in response to a request from a user (e.g., a request generated via a GUI provided by the GUI module 520). The reports may include the average time each processing step takes, trends in processing times (e.g., whether the time taken to compete each step is increasing or decreasing), and any other pertinent information. Thus, among other things, the reports may assist in identifying system performance issues and predict need for increased (or decreased) system capacity to meet future demand. In some embodiments, the reporting module 540 may also generate different types of reports. For example, a user representing an entity might generate a report indicating the total value of transactions in which the entity was a payor or payee, or a net value of all transactions involving the entity, in different time periods (e.g., per week, per month, per year, etc.). Such a report may help the user identify trends in the entity's transactions.

The monitoring data 550 includes the data objects representing transactions and is stored using one or more computer-readable media. In one embodiment, the monitoring data 550 is stored on a hard drive of the transaction monitoring system 120. Although the monitoring data 550 is shown as a single entity located within the transaction monitoring system 120, in some embodiments, the monitoring data may be distributed across multiple devices or storage media. For example, the monitoring data 550 might be stored in a distributed database and accessed by the transaction monitoring system 120 remotely (e.g., via the network 170).

The mapping data 560 indicates correlations between transaction IDs used by different systems to identify the same transaction. For example, as described above, the sender's systems, the transaction orchestration platform 110, and the payment clearing system 130 may each use a different identifier for a single transaction. In other embodiments, there may be a greater or lesser number of identifiers used for each transaction within the networked computing environment 100. As with the monitoring data 550, the mapping data 560 may be stored on a hard drive or other computer readable medium of the transaction monitoring system 120 or remotely (e.g., in a distributed database).

Example Methods

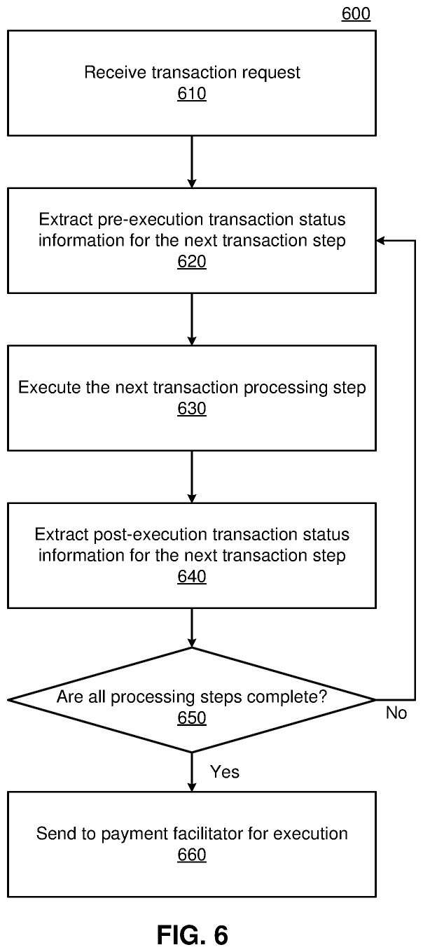

FIG. 6 illustrates a method 600 for processing a transaction request and providing transaction lifecycle monitoring, according to one embodiment. The steps of FIG. 6 are illustrated from the perspective of the transaction orchestration platform 110 performing the method 600. However, some or all of the steps may be performed by other entities or components. In addition, some embodiments may perform the steps in parallel, perform the steps in different orders, or perform different steps.

In the embodiment shown in FIG. 6, the method 600 begins with the transaction orchestration platform 110 receiving 610 a transaction request (e.g., from a sender's client device 140A). As described previously, the transaction request may include information about a desired transaction, such as identifiers of the sender and recipient, an amount to transfer, a currency to use, a date for the transaction to execute, or any other pertinent information.

The transaction orchestration platform 110 extracts 620 pre-execution transaction status information, executes 630 the first transaction processing step, and extracts 640 post-execution transaction status information. As described previously, the pre-execution and post-execution transaction status information may be extracted 620, 640 using a pair of advices and sent to the transaction monitoring system 120.

If all of the transaction processing steps are not complete 650, the transaction orchestration platform 110 extracts 620 pre-execution transaction status information for the next transaction processing step, executes 630 the next transaction processing step, and extracts 640 post-execution transaction status information for the next transaction processing step. This process iterates until all of the transaction processing steps are complete 650 and the transaction orchestration platform 110 sends 660 a message to a payment facilitator with instructions to execute the transaction.

The extracted transaction status information may be used by the transaction monitoring system 120 to provide insight into the status of the transaction and its progress through the transaction orchestration process. Because the embodiment shown in FIG. 6 extracts information before and after each processing step, the transaction monitoring system 120 may provide users with a detailed analysis of the processing of the transaction request. For example, users may see how long each step took to complete, helping them identify potential choke points, and may also be notified of problems (e.g., errors or exceptions) and provided opportunities to take corrective action. Thus, the approach described improves the efficiency of the transaction orchestration platform 110.

Trend analysis may enable efficient identification and mitigation of potential future problems before they arise (e.g., if the number of transaction requests is increasing over time, the entity managing the platform may add additional capacity before the platform becomes congested). Furthermore, the use of advices applied at pointcuts to extract transaction status information may enable the described approach to be implemented in existing transaction orchestration platforms 110 without the need to edit the code that implements the transaction request processing steps themselves.

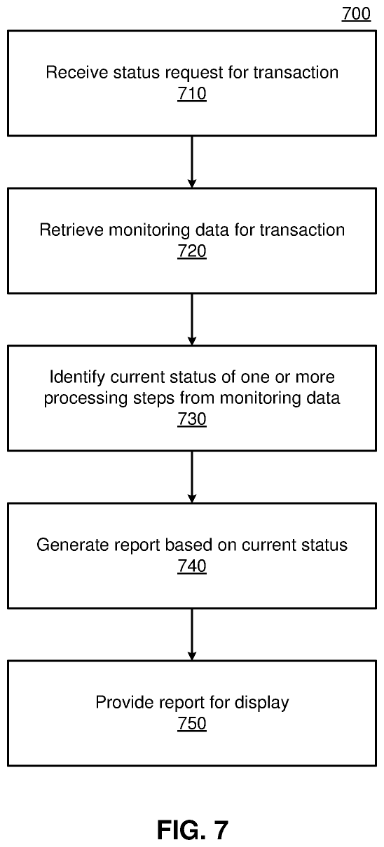

FIG. 7 illustrates a method 700 for providing a report on the current status of a transaction, according to one embodiment. The steps of FIG. 7 are illustrated from the perspective of the transaction monitoring system 120 performing the method 700. However, some or all of the steps may be performed by other entities or components. In addition, some embodiments may perform the steps in parallel, perform the steps in different orders, or perform different steps.

In the embodiment shown in FIG. 7, the method 700 begins with transaction monitoring system 120 receiving 710 a status request for a transaction. The status request may identify the transaction using one or more identifiers or other information about the transaction. As described in greater detail below, with reference to FIGS. 8A and 8B, in one embodiment, a user may provide an identifier from any of the systems involved in processing a transaction request and the transaction monitoring system 120 uses the mapping data 560 to identify the corresponding transaction record in the monitoring data 550. The user may also provide a partial identifier or other data that does not uniquely identify a transaction (e.g., a transaction amount) and select the desired transaction from a list of transactions that are consistent with the provided information.

Regardless of how the transaction is identified, the transaction monitoring system 120 retrieves 720 the corresponding monitoring data 550. The transaction monitoring system 120 identifies 730 the current status for one or more processing steps from the monitoring data 550. In one embodiment, the steps involved in processing a transaction are predetermined and loaded from a template. For example, a transfer of funds that is settled using the SWIFT network may go through a known series of steps. Alternatively, the steps involved in processing the transaction may be determined at dynamically from the monitoring data.

The transaction monitoring system 120 generates 740 a report based on the identified steps and corresponding statuses. The report may be provided 750 for display to the requesting user. For example, the user may identify the transaction with a user interface at a monitoring client device 140C and the transaction monitoring system 120 may provide 750 the report for display to the user at the monitoring client device 140C.

Example Graphical User Interface

FIGS. 8A-H illustrate components of an example user interface for viewing the status of a transaction. In various embodiments, some or all of the components shown in FIGS. 8A-H may be presented to a user as part of a graphical user interface. In the following paragraphs, the user interface is described as being displayed by a monitoring client device 140C, but the user interface may be displayed by other computing devices (e.g., the transaction monitoring system 120). The example user interface enables the user to identify a transaction of interest and view the lifecycle and status of that transaction. In other embodiments, the user interface may include different or additional elements than those shown.

FIG. 8A illustrates an example interface for identifying a transaction of interest. In the embodiment shown, the user interface includes a control 810 for opening a dropdown menu 812 via which the user may select a type of information to provide to identify the transaction of interest. In this case, the drop down 812 enables selection of three different identifiers (e.g., the sender's identifier, the transaction orchestration system's identifier, or the clearing system's identifier) or the transaction amount. The user interface also includes a search box 814 in which the user may enter a search term (e.g., a complete or partial transaction identifier or amount. The user interface also includes a search button 816 that the user may select to initiate the search. Alternatively, the search may be conducted and updated automatically as the user enters information into the search box 814. In another embodiment, the control 810 and dropdown menu 812 are omitted and the type of information provided by the user is determined automatically. For example, different identifiers may have different format, and thus the type of identifier may be determined from the format of the information provided by the user.

As illustrated in FIG. 8B, if the user selects amount from the dropdown menu 812, an additional control 820 for opening a second dropdown menu 822 may be displayed. The second dropdown menu 822 enables the user to select a currency in which to provide the amount of the transaction. In FIG. 8B, the second dropdown menu 822 enables the user to choose between US dollars or Euros. In other embodiments, the second dropdown menu 822 may include different or additional currencies.

FIG. 8C illustrates a set of search results displayed in a results portion 830 of the example interface. The user has selected ID1 using control 810, typed a partial identifier (103usd) into the search box 814, and selected the search button 816. The transaction monitoring system 120 has identified transactions for which ID1 includes the partial identifier and provided information regarding those transactions to the monitoring client device 140C. The information may include each identifier used for the transaction (e.g., as indicated by the mapping data 560), the date the transaction request was submitted, the currency of the transaction, the amount of the transaction, or any other pertinent information. In the case shown in FIG. 8C, the partial identifier matches more transactions than can be displayed in a single page, so the user interface also includes navigation controls 832 to view an additional page or pages of results. Alternatively, the results may be displayed on the single page and the user interface may include one or more scroll bars to enable the user to navigate through the results.

FIG. 8D illustrates the display of a selected transaction in the example user interface. The user has selected a transaction (e.g., by clicking on it in the results portion 830 of the user interface) causing display of additional information regarding the selected transaction. In the embodiment shown, the identifying information 840 from the search results in displayed along with a transaction flow diagram 841 including a set of nodes. Each node corresponds to a different processing step of the transaction. In FIG. 8D, the nodes are labelled generically (node 1, node 2, etc.) but, in practice, the nodes may be labelled with the name of the corresponding processing step (e.g., funds availability service, sanctions check service, SWIFT, etc.). Because the mapping data 560 correlates the different identifiers used to refer to same transaction throughout its lifecycle, the transaction flow diagram 841 can represent the lifecycle of the transaction, from submission by a sender's client device 140A to completion by a payment clearing system 130.

The current status information for processing steps may be indicated by one or more visual properties of the corresponding nodes, including color, shape, pattern, size, and the like. The current processing step may be identified by an indicator 842. For example, in FIG. 8D, nodes 2 and 5 are completely filled indicating the monitoring data 550 includes confirmation from the relevant system that the corresponding processing step was completed successfully. Nodes 1, 3, 4, 6, 7, and 8 are partially filled indicating that, although status data is not available for the corresponding processing step, it can be inferred the step completed successfully as processing has proceeded to a later step. Nodes 9, 10, and 11 are not filled indicating these steps are either underway or yet to be started. Other visual properties may be used to indicate that: the transaction may be stuck at a particular step (e.g., if no confirmation of success or failure has been received for the current step and more than a threshold amount of time has passed), the transaction has settled, the transaction has been cancelled, and/or there has been a technical or business failure in the corresponding component that may require further investigation.

In addition to the transaction flow diagram 841, the user interface may include a window 843 for presenting detailed information regarding the transaction. The window 843 includes tabs 844, 845, 846 for selecting the level of additional detail to be presented and an information display area 847 for displaying the detailed information. In the embodiment shown in FIG. 8D, the window 843 includes a last update tab 844, a summarized history tab 845, and a detailed history tab 846. In other embodiments, different or additional tabs may be included, which may depend on the permission or status of the user. For example, a system administrator may have access to the full detailed history of a transaction while a representative of the sender may be limited to seeing the summarized history or last update.

In FIG. 8D, the last update tab 844 is currently selected, causing information regarding the most recent status update for the transaction to be displayed in the information display area 847. In this case, that transaction is at the step corresponding to node 9, the date and time that the last update was received for that step, and a brief summary, such as a task code and description of current processing activity.

In FIG. 8E, the user has selected the summarized history tab 845. As a result, the information display area 847 has been updated to show a summarized history of the transaction's progress through its processing lifecycle. In one embodiment, the summarized history indicates the date and time that each step began (or completed) and the amount of time that step took to complete (or that has currently elapsed in the case on an on-going step). The summarized history may also provide a brief text description of the processing step. If the summarized history is too large to display in the information display area 847, the user interface may include controls for scrolling or otherwise navigating through the summarized history.

In FIG. 8F, the user has selected the detailed history tab 846. As a result, the information display area 847 has been updated to show a detailed history of the transaction's progress through its processing lifecycle. In one embodiment, the detailed history includes headings for processing steps along with dates, times, and text summaries of each update relating to those processing steps (e.g., receipt of the transaction at a processing step system, completion of substeps within the processing step, completion of the processing step, etc.). If the detailed history is too large to display in the information display area 847, the user interface may include controls for scrolling or otherwise navigating through the detailed history. In some embodiments, the user interface may also include links to view the full payload of data available for processing steps.

FIG. 8G illustrates an embodiment where additional information about a processing step is additionally or alternatively displayed in proximity to the correspond node. FIG. 8G shows a portion of a transaction flow diagram 841. A first node 871 and a second node 872 have a first visual property (e.g., filled with green stripes), indicating status data is not available but the system has inferred that the corresponding steps successfully completed. A third node 873 has a second visual property (e.g., filled solidly in green) indicating status data is available indicating the corresponding processing step completed successfully. In contrast, a fourth node 874 has a third visual property (e.g., filled in red) indicating the corresponding processing step failed. A fifth node 875 has a fourth visual property (e.g., being unfilled/white) indicating that the corresponding processing step has not started (because the previous step failed).

The user has selected the third node (e.g., by hovering their mouse cursor over it or clicking on it) causing additional information to be displayed in a bubble 876 above it. This information may include the last event performed in the processing step, a start timestamp indicating when the processing step began, and an end timestamp indicating when the processing step ended. Thus, the user can investigate the processing of the transaction in further detail (e.g., in this case, to evaluate why the fourth processing step failed).

In some cases, a transaction processing step may be a grouping of multiple individual transactions. For example, a company paying its employees' salaries may wish to submit and track its payroll as a single transaction, which ultimately results in multiple individual payments to its employees. In some embodiments, the user interface may represent this by including a split in the transaction flow diagram 841 to have multiple parallel nodes, each parallel node corresponding to one of the individual payments.

An example of a transaction flow diagram 841 that splits to represent multiple payments is shown in FIG. 8H. In the embodiment shown, a first node 881 has a first visual property (e.g., being filled in green) indicating the correspond payment step has successfully completed. At this stage, the collective processing is complete (e.g., the company's request to pay all of its employees has passed credit, sanctions, and any other required checks). The transaction flow diagram 841 splits to include multiple parallel nodes (in this case three) corresponding to each individual payment. Of the parallel nodes, a second node 882 and a third node 883 have a second visual property (e.g., being filled in blue) indicating the corresponding payment has been made. In contrast, a fourth node 884 of the parallel nodes has a third visual property (e.g., being filled in red) indicating the corresponding payment failed for some reason. As a result, a fifth node 885 has a fourth visual property (e.g., being filled in yellow) indicating that full processing of the transaction request may be held up (in this case, because the payment corresponding to the fourth node 884 failed). A sixth node has a fifth visual property (e.g., being unfilled/white) indicating the corresponding processing step has not begun (because the previous step has not yet successfully completed). Thus, the user may determine which specific payments failed and more efficiently investigate the root cause.

Computing System Architecture

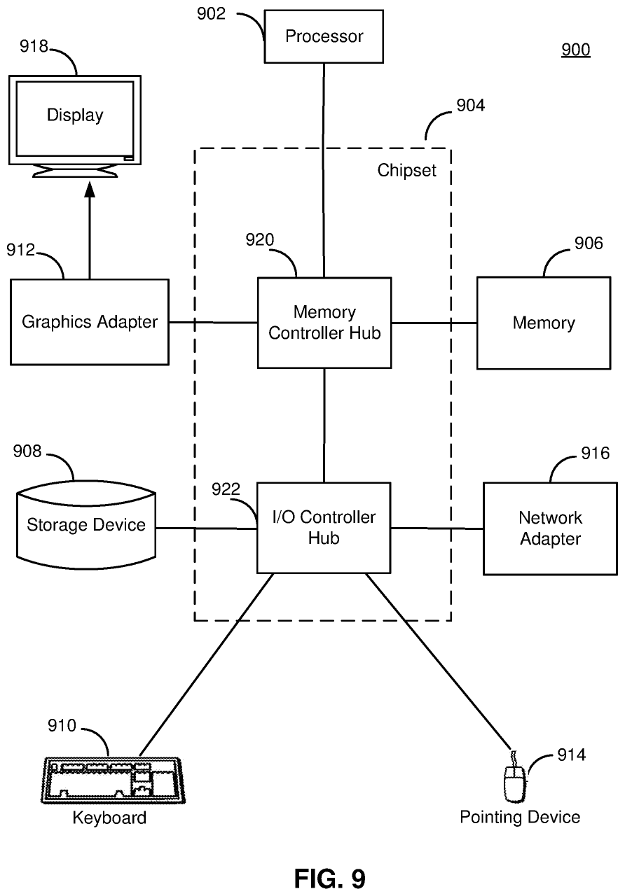

FIG. 9 illustrates an example computer 900 suitable for use as a client device 140, a transaction monitoring system 120, or as part of a transaction orchestration platform 110. The example computer 900 includes at least one processor 902 coupled to a chipset 904. For convenience, the processor 902 is referred to as a single entity but it should be understood that the corresponding functionality may be distributed among multiple processors using various ways, including using multi-core processors, assigning certain operations to specialized processors (e.g., graphics processing units), and dividing operations across a distributed computing environment. Any reference to a processor 902 should be construed to include such architectures.

The chipset 904 includes a memory controller hub 920 and an input/output (I/O) controller hub 922. A memory 906 and a graphics adapter 912 are coupled to the memory controller hub 920, and a display 918 is coupled to the graphics adapter 912. A storage device 908, keyboard 910, pointing device 914, and network adapter 916 are coupled to the I/O controller hub 922. Other embodiments of the computer 900 have different architectures.

In the embodiment shown in FIG. 9, the storage device 908 is a non-transitory computer-readable medium such as a hard drive, compact disk read-only memory (CD-ROM), DVD, or a solid-state memory device. The memory 906 holds instructions and data used by the processor 902. The pointing device 914 is a mouse, track ball, touch-screen, or other type of pointing device, and is used in combination with the keyboard 910 (which may be an on-screen keyboard) to input data into the computer system 900. The graphics adapter 912 causes images and other information to be presented on the display 918 (which may be part of the computer system or a remote device, such as a projector). The network adapter 916 couples the computer system 900 to one or more computer networks (e.g., network 170).

The types of computers used by the entities of FIGS. 1-3 and 5 can vary depending upon the embodiment and the processing power required by the entity. For example, the transaction orchestration platform 110 might include a distributed database system including multiple servers working together to provide the functionality described. Furthermore, a computer can lack some of the components described above, such as keyboards 910, graphics adapters 912, and displays 918.

Additional Considerations

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise.

Finally, while particular embodiments and applications have been illustrated and described, it is to be understood that these embodiments are illustrative. Various modifications, changes, and variations to the disclosed examples may be apparent to those skilled in the art. Accordingly, the disclosed embodiments should not be considered limiting on the scope of protection. Rather, the scope of protection should be limited only by the following claims.

What is claimed is:

1. A transaction lifecycle monitoring system comprising:
a monitoring data datastore configured to store monitoring data for transactions, wherein at least some of the transactions have monitoring data generated by multiple processing systems;
a report generation module configured to:
receive a status request for a transaction;
retrieve monitoring data for the transaction from the monitoring datastore;
identify a current status of the transaction at each of a plurality of processing steps based on the retrieved monitoring data; and
generate a report based on the current status of the transaction at each of the plurality of processing steps; and
a graphical user interface (GUI) module configured provide the report generated by the report generation module for display in a GUI.

2. The transaction lifecycle monitoring system of claim 1, wherein the status request includes a first transaction identifier of the transaction, and the transaction lifecycle monitoring system further comprises:
a mapping data store configured to store mapping data that correlates different identifiers used by the processing systems to identify single transactions,
wherein the report generation module is further configured to query the mapping data using the first identifier to identify a second identifier of the transaction, and
wherein the monitoring data retrieved for the transaction includes monitoring data associated with both the first transaction identifier and the second transaction identifier.

3. The transaction lifecycle monitoring system of claim 1, further comprising an ingestion module configured to:
receive monitoring data for the transaction in conjunction with a sender's identifier for the transaction;
receive additional monitoring data for the transaction in conjunction with an orchestration platform identifier for the transaction and an indication that the orchestration platform identifier corresponds to the sender's identifier;
store the monitoring data and the additional monitoring data in the monitoring datastore; and
store an indication that both the monitoring data and the additional monitoring data correspond to the transaction.

4. The transaction lifecycle monitoring system of claim 3, further comprising a mapping datastore, wherein the indication that both the monitoring data and the additional monitoring data correspond to the transaction includes a mapping, in the mapping datastore, between the sender's identifier and the orchestration platform identifier.

5. The transaction lifecycle monitoring system of claim 3, wherein the ingestion module is further configured to:
receive further monitoring data for the new transaction;
store the further monitoring data in the monitoring datastore; and
store an indication that the further monitoring data corresponds to the transaction.

6. The transaction lifecycle monitoring system of claim 1, wherein the monitoring data includes data extracted by advices, each advice applied before or after a corresponding one of the plurality of processing steps.

7. The transaction lifecycle monitoring system of claim 1, wherein the report generation module being configured to identify the current status of the transaction at each of the plurality of processing steps comprises being configured to:
determine that the retrieved monitoring data does not include a current status for a first processing step of the plurality of processing steps;
determine that the retrieved monitoring data includes an indication that a second processing step of the plurality of processing steps was successfully completed, the second processing step occurring after the first processing step according to an expected series of steps for processing the transaction; and
infer that the first processing step completed successfully based on the second processing step having completed successfully.

8. The transaction lifecycle monitoring system of claim 1, wherein the report comprises a timeline including geometric shapes corresponding to the plurality of processing steps, wherein a visual property of each geometric shape indicates the current status of the corresponding processing step.

9. The transaction lifecycle monitoring system of claim 8, wherein the visual property is color.

10. The transaction lifecycle monitoring system of claim 8, wherein the GUI provides additional information about a particular processing step in response to user selection of the geometric shape corresponding to the particular processing step.

11. The transaction lifecycle monitoring system of claim 8, wherein the transaction comprises a plurality of sub-transactions and, for at least one of the processing steps, the timeline includes geometric shapes corresponding to each of the sub-transactions, a visual property of the geometric shapes corresponding to the sub-transactions indicating the current status of the sub-transactions at the at least one of the processing steps.

12. The transaction lifecycle monitoring system of claim 1, wherein the GUI includes controls configured to enable a user to select the transaction from among the transactions, and the status request is generated responsive to user-selection of the transaction via the GUI.

13. The transaction lifecycle monitoring system of claim 12, wherein the GUI module is further configured to receive identifying data provided via user input to the GUI, identify a subset of the transactions consistent with the identifying data, and provide the subset for display in the GUI in conjunction with controls for selecting the transaction from among the subset.

14. The transaction lifecycle monitoring system of claim 13, wherein the identifying data includes at least one of: a portion of an identifier used by one of the processing systems to identify the transaction or a transaction amount.

15. A method for transaction lifecycle monitoring, the method comprising:
receiving a status request for a transaction;
retrieving, from a database, monitoring data for the transaction, the monitoring data including status data generated by multiple transaction processing systems;
identifying a current status of the transaction at each of a plurality of processing steps based on the retrieved monitoring data;
generating a report based on the current status of the transaction at each of the plurality of processing steps; and
providing the report for display in a GUI.

16. The method of claim 15, wherein the status request includes a first transaction identifier of the transaction used by a first transaction processing system, and retrieving the monitoring data comprises:
querying a mapping data store using the first transaction identifier to identify a second transaction identifier used to identify the transaction by a second processing system; and
querying the database using the first and second transaction identifiers to retrieve monitoring data generated by the first and second transaction processing systems.

17. The method of claim 15, wherein identifying the current status of the transaction at each of the plurality of processing steps comprises:
determining that the retrieved monitoring data does not include a current status for a first processing step of the plurality of processing steps;
determining that the retrieved monitoring data includes an indication that a second processing step of the plurality of processing steps was successfully completed, the second processing step occurring after the first processing step according to an expected series of steps for processing the transaction; and
inferring that the first processing step completed successfully based on the second processing step having completed successfully.

18. The method of claim 15, wherein the report comprises a timeline including geometric shapes corresponding to the plurality of processing steps, wherein a visual property of each geometric shape indicates the current status of the corresponding processing step.

19. The method of claim 15, wherein the GUI includes controls configured to enable a user to select the transaction from among a plurality of transactions, the method further comprising:
receiving identifying data provided via user input using the controls;
identifying a subset of the plurality of transactions consistent with the identifying data; and
providing the subset for display in the GUI in conjunction with controls for selecting the transaction from among the subset,
wherein the status request is generated responsive to user-selection of the transaction via the GUI.

20. A non-transitory computer-readable medium storing instructions that, when executed by a computing device, cause the computing device to perform operations comprising:
displaying a GUI including controls configured to enable a user to select a transaction from among a plurality of transactions;
receiving identifying data provided via user input using the controls;
identifying a subset of the plurality of transactions consistent with the identifying data;
providing the subset for display in the GUI in conjunction with controls for selecting the transaction from among the subset;
receiving user selection, using the controls, of a transaction;
sending, to a transaction monitoring system, a status request for the transaction;
receiving, from the transaction monitoring system, a report regarding the transaction, the report including a current status of the transaction at each of a plurality of transaction processing steps, the report generated from monitoring data generated by multiple transaction processing systems that each use a different identifier to identify the transaction; and
displaying the report in the GUI.
